(19) United States
(12) Patent Application Publication
(10) Pub. No.: US 2011/0069483 A1
(43) Pub. Date: Mar. 24, 2011

(54) LED LIGHTING DEVICE

(75) Inventor: Yu-Jui TSAO, Kaohsiung City (TW)

(73) Assignee: SI POWER TECHNOLOGY CO., LTD, Kaohsiung CIty (TW)

(21) Appl. No.: 12/796,769

(22) Filed: Jun. 9, 2010

(30) Foreign Application Priority Data
Sep. 21, 2009 (TW) 098217348

(51) Int. Cl. F21V 1/00

(52) U.S. Cl. 362/235

(57) ABSTRACT

An LED lighting device produces subdued and surface light that does not damage people's eyes, has a concave top, an open bottom and two ends and comprises two supports, a reflector, a housing cavity, a mounting base and an LED strip. The two supports are mounted respectively at the two ends parallel to each other, and each support has an inner surface. The reflector is a concave non-metallic white reflective sheet, mounted longitudinally between and attached to the two supports, and has an inner surface. The housing cavity is formed between the two inner surfaces of the two supports and the inner surface of the reflector. The mounting base is mounted longitudinally between and attached to the two supports and has two rails. The LED strip is mounted movably between the two rails and has at least one LED facing the inner surface of the reflector to emit light.

### FIELD OF THE INVENTION

The present invention relates to a light-emitting diode (LED) lighting device that produces subdued and surface light and does not damage people's eyes.

### BACKGROUND OF THE INVENTION

Light-emitting diodes (LEDs) are semiconductor and solid-state light sources and emit light when electric current passes through them. LEDs have advantages of not being toxic, being small and having a long lifespan, high resistance to shock, rapid response and low power consumption. Consequently LEDs are used in many lighting applications. However, light emitted by conventional LEDs is harsh, is emitted from a single point and damage people's eyes.

Accordingly, a need exists for an LED lighting device that produces subdued and surface light that does not damage people's eyes.

### SUMMARY OF THE INVENTION

An objective of the present invention is to provide a light-emitting diode (LED) lighting device that produces subdued and surface light and does not damage people's eyes.

The LED lighting device in accordance with the present invention produces subdued and surface light that does not damage people's eyes, has a concave top, an open bottom and two ends and comprises two supports, a reflector, a housing cavity, a mounting base and an LED strip. The two supports are mounted respectively at the two ends parallel to each other, and each support has an inner surface. The reflector is a concave non-metallic white reflective sheet, mounted longitudinally between and attached to the two supports, and has an inner surface. The housing cavity is formed between the two inner surfaces of the two supports and the inner surface of the reflector. The mounting base is mounted longitudinally between and attached to the two supports and has two rails. The LED strip is mounted movably between the two rails and has at least one LED facing the inner surface of the reflector to emit light.

### BRIEF DESCRIPTION OF THE DRAWINGS

FIG. 1 is an exploded perspective view of a light-emitting diode (LED) lighting device in accordance with the present invention.

FIG. 2 is a perspective view of the LED lighting device in FIG. 1.

FIG. 3 is an end view in partial section of the LED lighting device in FIG. 1.

FIG. 4 is an end view of the LED lighting device in FIG. 1 with reflected light rays.

### DETAILED DESCRIPTION OF THE PRESENT INVENTION

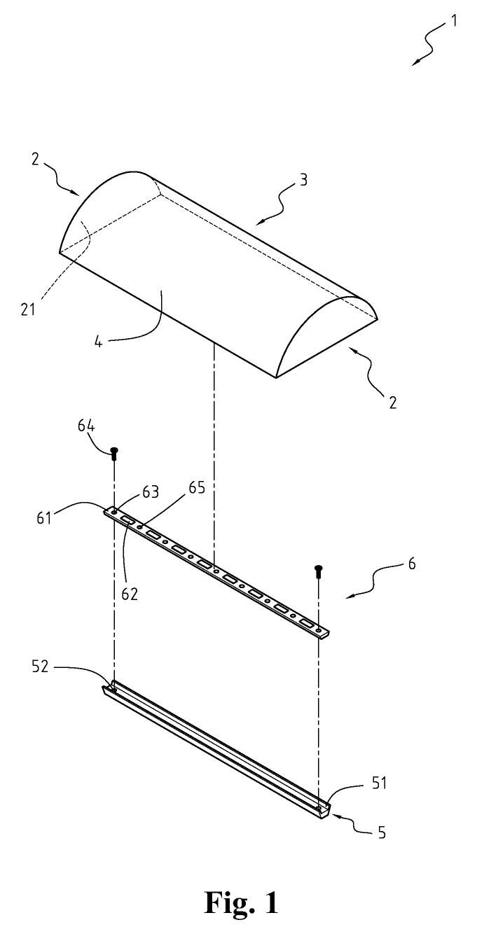

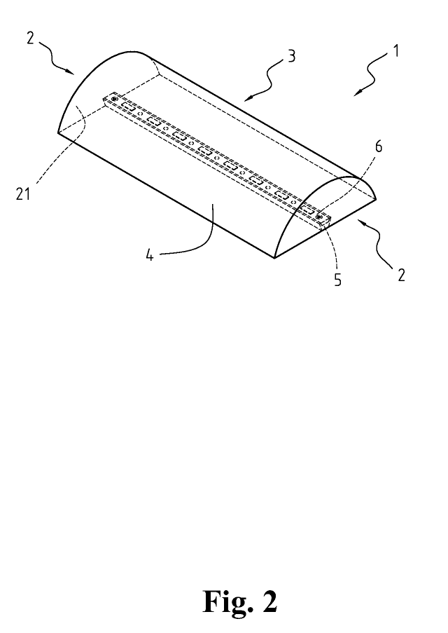

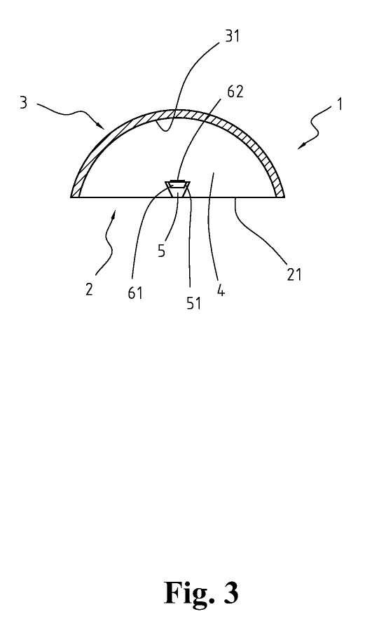

With reference to FIGS. 1 to 3, a light-emitting diode (LED) lighting device (1) produces subdued and surface light that does not damage people's eyes, has a concave top, an open bottom and two ends and comprises two supports (2), a reflector (3), a housing cavity (4), a mounting base (5) and an LED strip (6).

The two supports (2) are mounted respectively at the two ends parallel to each other, and each support (2) has an upper edge, a bottom edge, an inner surface (21) and an outer surface. The two upper edges are parallel to each other, and each upper edge is curved and has two ends. The two bottom edges are parallel to each other and correspond respectively to the two ends. The two inner surfaces (21) face each other, and each inner surface (21) is formed transversely between and attached to the corresponding upper edge and the corresponding bottom edge. Each outer surface is formed transversely between and attached to the corresponding upper edge and the corresponding bottom edge and opposite to the corresponding inner surface (21).

The reflector (3) is a concave non-metallic white reflective sheet, mounted longitudinally between and attached to the two supports (2), and has an outer surface, an inner surface (31) and two curved edges and two sides. The inner surface (31) is concave, formed longitudinally between the two inner surfaces (21) of the two supports (2) and faces the open bottom. The two curved edges are parallel to and aligned with each other and attached respectively to the two upper edges of the two supports (2). The two sides are parallel to each other and aligned with each other and formed longitudinally between the two curved edges.

The housing cavity (4) is formed between the two inner surfaces (21) of the two supports (2) and the inner surface (31) of the reflector (3).

The mounting base (5) may be made of aluminum and is mounted longitudinally between and attached to the two supports (2) and has an upper surface, a bottom surface, two sides, two ends, two rails (51) and two optional holes (52). The upper surface may be coated with a layer of complex with aluminum oxide. The bottom surface is parallel to the upper surface of the mounting base (5) and the two sides of the reflector (3) and formed longitudinally between the inner surfaces (21) of the supports (2). The two sides are formed transversely between the upper surface of the mounting base (5) and the bottom surface of the mounting base (5). The two ends are attached respectively to the inner surfaces (21) of the supports (2). The two rails (51) are formed on and protrude up from the upper surface of the mounting base (5) parallel to the two sides of the mounting base (5). The two holes (52) are formed through the upper surface of the mounting base (5) near the two ends.

The LED strip (6) is mounted movably between the rails (51) and has a substrate (61) and at least one LED (62). The substrate (61) is mounted longitudinally between the two ends of the mounting base (5) and has an upper surface, a bottom surface, two optional through holes (63), two optional screws (64) and multiple optional cooling holes (65). The upper surface faces the inner surface (31) of the reflector (3). The bottom surface is parallel to the upper surface of the substrate (61) and is attached to the upper surface of the mounting base (5). The two through holes (63) are formed through the substrate (61) and correspond respectively to the two holes (52) of the mounting base (5). The two screws (64) are mounted respectively through the two holes (52) of the mounting base (5) and screwed respectively into the two through holes (63) of the substrate (61).

The LED (62) is mounted on the upper surface of the substrate (61) and faces the inner surface (31) of the reflector (3) to emit light.

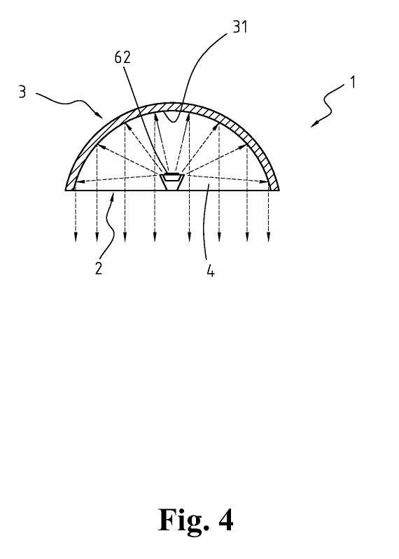

With further reference to FIG. 4, the light emitted by the LED (62) passes through the housing cavity (4) and is reflected by the inner surface (31) of the reflector (3) to transform the light into subdued and surface light that does not damage people's eyes.

What is claimed is:

1. A light-emitting diode (LED) lighting device producing subdued and surface light that does not damage people's eyes, having a concave top, an open bottom and two ends and comprising
two supports being mounted respectively at the two ends parallel to each other, and each support having
an upper edge being curved and having two ends and the two upper edges being parallel to each other;
a bottom edge and the two bottom edges being parallel to each other and corresponding respectively to the two ends;
an inner surface being formed transversely between and attached to the corresponding upper edge and the corresponding bottom edge and the two inner surfaces facing each other; and
an outer surface being formed transversely between and attached to the corresponding upper edge and the corresponding bottom edge and opposite to the corresponding inner surface;
a reflector being a concave non-metallic white reflective sheet, mounted longitudinally between and attached to the two supports, and having
an outer surface;
an inner surface being concave, formed longitudinally between the two inner surfaces of the two supports and facing the open bottom;
two curved edges being parallel to and aligned with each other and attached respectively to the two upper edges of the two supports; and
two sides being parallel to each other and aligned with each other and formed longitudinally between the two curved edges;
a housing cavity being formed between the two inner surfaces of the two supports and the inner surface of the reflector;
a mounting base being mounted longitudinally between and attached to the two supports and having
an upper surface;
a bottom surface being parallel to the upper surface of the mounting base and the two sides of the reflector and formed longitudinally between the inner surfaces of the supports;
two sides being formed transversely between the upper surface of the mounting base and the bottom surface of the mounting base;
two ends being attached respectively to the inner surfaces of the supports; and
two rails being formed on and protruding up from the upper surface of the mounting base parallel to the two sides of the mounting base; and
an LED strip being mounted movably between the two rails and having
a substrate being mounted longitudinally between the two ends of the mounting base and having
an upper surface facing the inner surface of the reflector; and
a bottom surface being parallel to the upper surface of the substrate and attached to the upper surface of the mounting base; and
at least one LED being mounted on the upper surface of the substrate and facing the inner surface of the reflector to emit light.

2. The LED lighting device as claimed as claim 1, wherein the mounting base has two holes being formed through the upper surface of the mounting base near the two ends.

3. The LED lighting device as claimed as claim 2, wherein the substrate has two through holes being formed through the substrate and corresponding respectively to the two holes of the mounting base.

4. The LED lighting device as claimed as claim 3, wherein the substrate has two screws being mounted respectively through the two holes of the mounting base and screwed respectively into the two through holes of the substrate.

5. The LED lighting device as claimed as claim 1, wherein the upper surface of the mounting base is coated with a layer of complex with aluminum oxide.

6. The LED lighting device as claimed as claim 1, wherein the mounting base is made of aluminum.

7. The LED lighting device as claimed as claim 4, wherein the substrate has multiple cooling holes.
